(19) United States
(12) Patent Application Publication
(10) Pub. No.: US 2025/0009146 A1
(43) Pub. Date: Jan. 9, 2025

(54) DEVICE FOR STORING EVERYDAY OBJECTS AND A MUSIC MODULE FOR AN EVERYDAY OBJECT

(71) Applicant: TRADARIS LIMITED, Sheung Wan (HK)

(72) Inventor: Christian LECHNER, Wiesing (AT)

(21) Appl. No.: 18/756,300

(22) Filed: Jun. 27, 2024

(30) Foreign Application Priority Data
Jul. 3, 2023 (CN) 202321721458.7

(51) Int. Cl. A47F 7/02; H04R 1/02

(52) U.S. Cl. CPC A47F 7/02; H04R 1/025

(57) ABSTRACT

The invention relates to a device for storing everyday objects, in particular, a jewellery box, comprising a base body, which comprises at least one storage space, wherein the base body comprises at least one base-body opening, and with a closure body for closing at least one base-body opening. On the base body, there is at least one music module with at least one loudspeaker for playing at least one piece of music and there is an electronic unit that plays at least two pieces of music.

### CROSS-REFERENCE TO RELATED APPLICATIONS

This application claims the benefit of priority to Chinese Patent Application Number 202321721458.7 filed on Jul. 3, 2023. The entire contents of the above-identified application are hereby incorporated by reference.

The present invention relates to a device for storing everyday objects according to the generic term of Claim 1 and a music module for an everyday object according to Claim 10.

### TECHNOLOGICAL BACKGROUND

DE 20 2014 005616 U1 is known from prior art. This reveals a jewellery box with a base body and a closure lid to close the base body, wherein the closure lid comprises a front surface. The closure lid is formed in at least two parts consisting of a base body with a front surface and a metal plate, wherein the front surface of the base body comprises a recess with a circumferential rim, the contour of which corresponds to the contour of the metal plate. The metal plate is taken up in the recess and connected to the base body.

DE 20 2010 001559 U1 is known from prior art. This discloses a storage device, in particular, a jewellery box or a watch case, with at least one lid-like flap for opening the storage device, wherein this comprises one power source and at least two illuminants, wherein the illuminants are perceptibly arranged on the outer surface of the storage device and/or on a hanger attached to the storage device. A generic device is disclosed in DE29813929 U1.

DE 1984 11 163 U1 is known from prior art. This discloses a jewellery box with a closure lid that can be flapped open, wherein this comprises a battery-operated musical mechanism and an on-off switch is arranged in the power supply, the actuating element of which is connected to the hinged lid.

The disadvantage of these well-known solutions is that they are essentially purely mechanical and tend to be heavy objects. In addition, these are not designed as children's toys and can only play a single piece of music, if at all.

### PRESENTATION OF THE INVENTION

One of the objects of the invention is to avoid at least one of the disadvantages of prior art. The aim is to create a device that is particularly lightweight and compact and allows a varied and individual selection of pieces of music. Furthermore, a music module is to be created that can be easily integrated into an everyday object and can be used in a variety of ways.

This task is achieved by means of the features of the independent claims. Favourable further embodiments are shown in the figures and in the dependent claims.

A device for storing everyday objects according to the invention, in particular, a jewellery box or a treasure chest, comprises a base body which comprises at least one storage space, wherein the base body comprises at least one base-body opening, and a closure body for closing which comprises at least one base-body opening. On the base body, there is at least one music module with at least one loudspeaker for playing at least two pieces of music and there is an electronic unit that plays at least two pieces of music.

The device not only serves as a storage item but can also be used to play music and thus as a jukebox. The device can be essentially made of plastic or lightweight fibreboard or other lightweight materials, making it lightweight and compact, as well as being protected against splashing water. It is favourably suitable as a play object for children, wherein the pieces of music can comprise children's songs. In addition, or as an alternative, the device is a jewellery box or a treasure chest with various compartments and drawers in the storage space in which individual pieces of jewellery can be stored.

Other embodiments of the device would be, for example, a spaceship, a car repair shop, a castle, or a horse stable, typically a building, or a vehicle, or an airplane. The device is a compact unit that can be closed with a closure body. An electronic unit can be an assembled printed circuit board with a programmable microcontroller that can store and play one or a plurality of pieces of music. The base body and the closure body can be made of lightweight wood fibreboard so that they are easy to assemble and have a particularly lightweight and compact design. The base body and the closure body can be made of plastic, for example, by injection moulding so that they can be easily produced in large quantities. The device is therefore inexpensive and can be produced economically.

Preferably, the electronic unit is designed to play at least two pieces of music if the closure body is at least partially distanced from the base-body opening In this way, there is an interplay of the positioning of the closure body on the base body and the playback of the musical pieces. One of the at least two pieces of music is played when the closure body is detached from the base body and thus does not fully rest on the base body. This allows everyday objects to be stowed away in the storage space of the base body, and at least one of the at least two pieces of music is played simultaneously.

Preferably, at least one sensor system is available, wherein the electronic unit uses at least one sensor system to detect that the closure body is at least partially distanced from the base-body opening. This means that at least two pieces of music can be played automatically if the electronic unit detects that the closure body is not connected to the base body in sections. Playing one of the at least two pieces of music is thus already started when the closure body is opened so you don't have to start playing it manually.

The sensor systems is preferably a light sensor or a switch. With the help of the light sensor, it is possible to automatically start playing one of the at least two pieces of music when light hits the light sensor. A switch allows the music module to be switched on and off mechanically so that the device can also be used without playing a piece of music. This is favourable if the device is located in the bedroom and the music is not to be played. For example, the switch is integrated into the base body and is held in one of its end positions by the closure body, at least temporarily so that the playback of at least two pieces of music can be prevented.

Preferably, the closure body is a hinged closure lid that is connected to the base body on one side of the closure lid. This means that the closure lid cannot be completely separated from the base body so that the closure lid cannot be lost. Playing one of the at least two pieces of music is thus already started when the closure lid is opened so you don't have to start playing it manually.

In particular, a display is arranged on the closure lid so that an animated representation or video can be output. The display can be connected to the electronic unit and thus output an animated representation, or a video adapted the playable piece of music. The display can be favourable with a touchscreen so that in addition to displaying animated representations or videos, there is also an operating function with which the electronic unit can be controlled and, where applicable, a piece of music can be selected.

Preferably, there is at least one storage device in which at least two pieces of music can be stored, wherein at least one storage device is connected to the electronic unit for the exchange of musical-piece data. This means that at least two pieces of music can be played repeatedly and reproducibly from the storage device to the electronic unit. In particular, a plurality of pieces of music are stored in at least one storage device, which can be transmitted separately and individually to the electronic unit in order to play them via the loudspeakers of the music module.

In particular, at least one storage device has a memory-card receptacle for an external memory card. This means that different pieces of music can be played from a memory card with the music module when the memory card is in the memory-card receptacle. The musical-piece data of the individual musical pieces can be read with the electronic unit and output via the loudspeakers of the music module.

Preferably, there is an operating device with which at least two pieces of music can be selected. The operating device comprises at least three operating units, wherein one operating unit can pause the playing of at least one piece of music, at least temporarily. Other operating units on the operating device can be used to select the different pieces of music or also to enable fast-forwarding or rewinding of the musical pieces. This means that the pieces of music can be selected individually and in a reproducible manner.

In particular, at least the volume of the piece of music can be adjusted using the operating device. The operating device comprises at least four operating units, wherein two of the operating units can be used for volume control. This means that the playback of one of the at least two pieces of music can be individually adjusted to local conditions.

Preferably, there is a power supply that is connected to the electronic unit. The power supply ensures that the at least two pieces of music can be played back in their entirety more than once without the user having to manipulate the device. For example, the power supply is a battery or power pack that allows the music to be played in a loop for hours. Conventional devices of this type have a mechanical musical mechanism that can be wound up by hand so that the only piece of music can only be played repeatedly for about 2-3 minutes.

In particular, the power supply can be connected to an external power supply via a USB port. This ensures the power supply even when travelling, as the device can be connected to a 5-volt power supply in the vehicle, for example.

In particular, there is an illumination unit that is supplied with the power supply. The illumination unit can be located in the storage space of the base body, or it can be located on the inner side of the closure body. This means that the storage space of the device can be illuminated when the closure body is separated from the base body. The device can therefore also be used in the dark. An illumination unit is favourably arranged on a mirror on the closure unit. When the closure body is open, a mirror becomes accessible, which can be used for make-up for example.

Preferably, there is a WLAN module that is connected to the electronic unit. This means that different pieces of music can be sent wirelessly to the music module, which can then be played back with the help of the electronic unit or stored in the storage device. This means that you can always save new pieces of music and play them individually.

In addition, or as an alternative, a Bluetooth module is available, which is connected to the electronic unit. With the help of Bluetooth®, various terminal devices, such as mobile phones or tablets, can be easily connected to the device. The device can be used as an external loudspeaker, for example to play at least two pieces of music from the terminal device.

Preferably, a motor for actuating a toy figure is arranged on or in the base body, wherein the electronic unit is designed to activate the motor if the closure body is at least partially distanced from the base-body opening. Such devices typically comprise toy figures. As is well known, these toy figures can be arranged in the storage space of the base body or on the outside of the closure body. As soon as the playing of at least one piece of music starts, a toy figure turns on the device. To do this, the toy figure is operatively connected to the motor shaft of the motor. The motor can be connected to the power supply to drive the motor shaft and can be switched on and off using the sensors. The toy figure is thus constantly actuated and can, for example, rotate over the entire duration of at least two pieces of music. A sudden premature stop of the toy figure while playing a piece of music can be prevented. The user can see from a greater distance that the toy figure is moving and can thus see, for example, that the closure body does not completely close the base body.

In particular, there is another switch that is connected to the electronic unit. The other switch is connected to the motor to switch it off manually so that the service life of the power supply, for example, the battery.

In particular, there is a pushbutton that can be used to activate an inclination of the toy figure. If the toy figure is tilted, for example, by shutting the closure lid closed, the pushbutton switch is activated to switch off the lighting in the base body or lighting on the mirror.

In particular, the toy figure can be removed. For this purpose, there is a connecting unit to which the toy figure is detachably arranged, and which is operatively connected to the motor shaft. This allows individual toy figures to be arranged on the device.

In particular, the toy figure is designed to perform dance movements, wherein the toy figure can have joints for this purpose, or a holding unit is arranged on the motor shaft, which sets the toy figure into motion to perform a dance movement when it rotates along with the motor shaft. The electronic unit is favourably designed to use the motor-shaft movement to make the toy figure perform individual dance movement depending on the piece of music being played, thereby being coordinated with the piece of music being played.

A music module for an everyday object according to the invention, in particular, a jewellery box, comprises at least one loudspeaker for playing at least two pieces of music and an electronic unit which plays the at least two pieces of music. Such a music module is favourable for children's play objects, wherein the pieces of music can comprise children's songs. The pieces of music are typically played one after the other.

The music module is compact and simple in design and can be individually positioned in different children's toys. An electronic unit can comprise an assembled printed circuit board with a programmable microcontroller that can store and play one or a plurality of pieces of music. Other embodiments of the music module according to the invention, with e.g. an operating device, WLAN module, Bluetooth®, storage device have already been disclosed before. The music module comprises a module housing made of plastic, in which the aforementioned individual components can be easily arranged, at least partially, and thus a lightweight and compact module can be manufactured. For example, the module housing can be made of plastic by injection moulding so that it can be easily produced in large quantities. The music module is therefore inexpensive and economically producible.

Further advantages, features and details of the invention result from the following description, in which exemplary embodiments of the invention are described with reference to the drawings.

The reference list is also an integral part of the disclosure like the technical content of the patent claims and figures are. The figures are comprehensively described in relation to one another. Identical reference numbers denote identical components, and reference numbers having different indices indicate functionally identical or similar components.

By means of the following figures, the invention is explained in more detail by means of exemplary embodiments. The reference list is part of the disclosure.

Position information, such as “above”, “below”, “right” or “left” are each related to the corresponding representations and are not to be understood as restrictive.

Although the invention is represented and described in detail by means of the figures and the corresponding description, this representation and this detailed description are illustrative and exemplary and not restrictive of the invention. It is to be understood that professionals can make changes and modifications without leaving the scope of the following claims. In particular, the invention also comprises embodiments with any combination of features mentioned or shown above for various aspects and/or embodiments.

The invention also comprises individual features in the figures, even if they are shown there in connection with other features and/or are not mentioned above. Furthermore, the term “comprise”, and derivatives thereof does not exclude other elements or steps. Likewise, the indefinite article “a” and “an” and derivatives thereof do not exclude a plurality. The functions of a plurality of features listed in the claims may be fulfilled by a single unit. The terms “essentially”, “about”, “approximately” and the like in connection with a property or a value also define, in particular, exactly the property or exactly the value. All reference numbers in the claims are not to be understood as limiting the scope of the claims.

### DESCRIPTION OF THE FIGURES

The figures are comprehensively described in relation to one another. The same reference numbers mean the same components. The figures show

FIG. 1: a device for storing everyday objects according to the invention, in particular, a jewellery box, with a music module in a perspective view,

FIG. 2: a first embodiment of a music module for storing everyday objects from the device in accordance with FIG. 1 in a perspective view, and

FIG. 3: another music module of the invention for a device for storing everyday objects in a perspective view.

### EMBODIMENT OF THE INVENTION

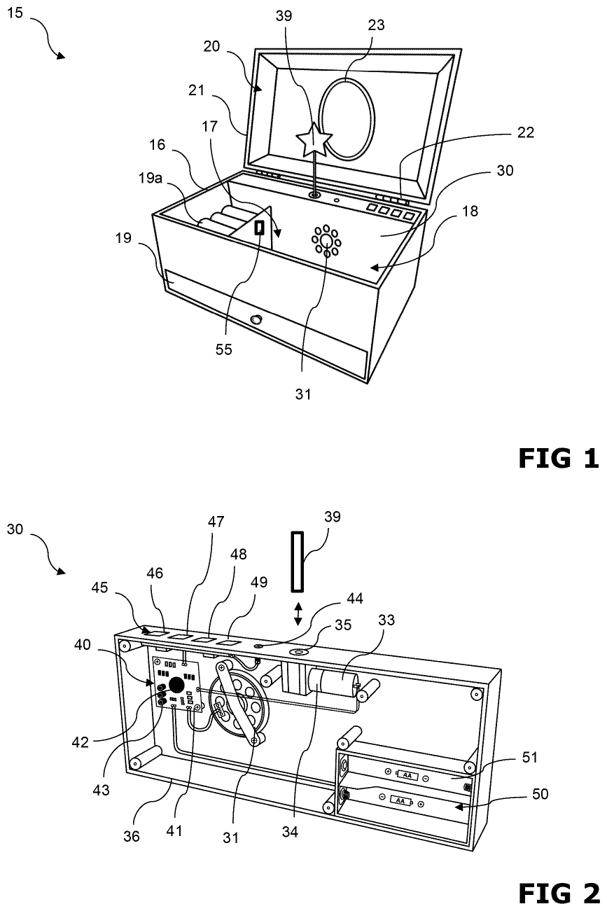

FIG. 1 shows the device 15 according to the invention as a jewellery box and comprises a base body 16, which comprises a storage space 17, wherein the base body 16 comprises a base-body opening 18, as well as a closure body 20 for closing the base-body opening 18. The device 15 is made of lightweight fibreboard and comprises a drawer 19, which is extendable in the lower part of the device 15. In the storage space 18, there is a placement area 19a, on which various objects, such as rings for example, can be placed. The closure body 20 is a hinged closure lid 21, which is connected to the base body 16 on one side of the closure lid 21 by means of hinges 22. On the inner side of the end cover 21, there is a mirror 23.

In the base body 16 is a music module 30 with a loudspeaker 31 for playing a plurality of pieces of music. The music module 30 comprises an electronic unit 40 for playing music. In this embodiment, the electronic unit 40 is an assembled printed circuit board 41 with a programmable microcontroller 42, which can store and play the musical pieces (FIG. 2). The electronic unit 40 is designed to play the pieces of music when the closure lid 21 is distanced from the base-body opening 18. There is a storage device 43 in which the musical pieces are stored, wherein the storage device 43 is electrically connected to the electronic unit 40 for the exchange of musical-piece data.

An operating device 45 is arranged on the music module 30, with which the musical pieces can be selected. In this embodiment, operating device 45 comprises four operating units 46, 47, 48, 49, wherein an operating unit 46 can stop and restart the playing of the musical pieces at least temporarily. Further operating units 47, 48 are used to select the different pieces of music, and also allow fast-forwarding or rewinding of the pieces of music. The operating unit 49 is used for volume control.

The electronic unit 40 is connected to a power supply 50 so that the music tracks can be played back in full more than once. The power supply 50 comprises batteries 51.

In the storage space 17, there is an illumination unit 55, which is supplied with the power supply 51. This means that the storage space 17 of the device 15 can be illuminated if the closure lid 21 is separated from the base body 16, or even if the closure lid 21 is arranged on the base body 16.

A switch 44 is located on the music module 30. Switch 44 is held in one of its end positions, at least temporarily, by the closure lid 21 so that the playback of one of the pieces of music can be prevented. Only when the closure lid 21 is opened is the switch 44 moved to another position. Switch 44 enables the music module 40 to be switched on and off mechanically by means of the movement of the closure lid 21, wherein the electronic unit 40 detects the position of the switch 44, and that the closure lid 21 is opened and is thus distanced from the base-body opening 18 in sections. Playing one of the music tracks starts as soon as the closure lid 21 is opened.

On the music module 40, a motor 33 is arranged on or in the base body 16 for actuating a toy FIG. 39, wherein the electronic unit 40 is designed to activate the motor 33 if the closure lid 21 is at least partially distanced from the base-body opening 18. The toy FIG. 39 is arranged in the storage space 17 of the base body 16. As soon as a piece of music starts playing, the toy FIG. 39 rotates. For this purpose, the toy FIG. 39 is operatively connected to the motor shaft 34 of the motor 33. The motor 33 is connected to the power supply 50 to drive the motor shaft 34. The toy FIG. 39 can be removed. For this purpose, there is a connecting unit 35, to which the toy FIG. 39 is arranged in a detachable manner and which is operatively connected to the motor shaft 34.

FIG. 2 shows the music module 30 described in FIG. 1 for an everyday object with the operating device 45, the removable toy figure and the switch 44 in a separate plastic housing 36.

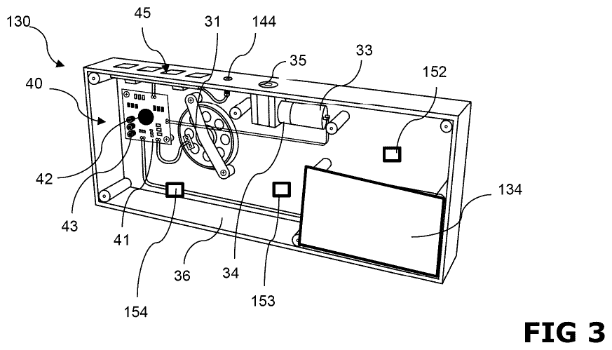

FIG. 3 shows the music module 30 described in FIG. 2 in a further embodiment, wherein the music module 130 also comprises a memory-card receptacle 134 for accommodating an external memory card. Furthermore, there is a WLAN module 152, which is connected to the electronic unit 30. In addition, or as an alternative, a Bluetooth module 153 is available, which is connected to the electronic unit 40. Instead of a switch, a light sensor 144 is available as a sensor. As soon as the closure lid 21 is opened and light falls on the light sensor 144, the electronic unit 40 reacts and a piece of music is played and emitted via the loudspeaker 31. The music module 130, which is open on one side, can be closed with a closure lid. Instead of the 50 power supply, a USB port 154 is provided, which can be connected to an external power supply. A display can be arranged on the closure lid 21.

The components listed in the music module 130 can also be arranged in the music module 30, and vice versa.

### REFERENCE LIST

15 device
16 base body
17 storage space
18 base-body opening
19 drawer
19a placement area
20 closure body
21 closure lid
22 hinges
23 mirror
30 music module
31 loudspeaker
33 motor
34 motor shaft
35 connection unit
36 plastic housing
39 toy FIG.
electronic unit
41 printed circuit board
42 microcontroller
43 storage device
44 switch
operating device
46 operating unit
47 operating unit
48 operating unit
49 operating unit
power supply
51 battery
55 illumination unit
130 music module
134 memory-card receptacle
144 light sensor
152 WLAN module
153 Bluetooth module
154 USB port

1. A device for storing everyday objects, in particular, a jewellery box or a treasure chest, comprising a base body comprises at least one storage space, wherein the base body comprises at least one base-body opening, and with a closure body for closing the at least one base-body opening, wherein there is at least one music module with at least one loudspeaker for playing at least two pieces of music on the base body, and that there is an electronic unit which plays at least two pieces of music.

2. The device according to claim 1, wherein the electronic unit is designed to play at least two pieces of music if the closure body is at least partially distanced from the base-body opening.

3. The device according to claim 1, wherein there is at least one sensor, wherein, with the aid of least one sensor, the electronic unit detects that the closure body is at least partially distanced from the base-body opening.

4. The device according to claim 3, wherein the sensor is a light sensor or a switch.

5. The device according to claim 1, wherein the closure body is a hinged closure lid which is connected to the base body on one side of the closure lid.

6. The device according to claim 5, wherein a display is arranged on the closure lid.

7. The device according to claim 1, wherein there is at least one storage device in which at least two pieces of music can be stored, wherein at least one storage device is connected to the electronic unit for the exchange of music data.

8. The device according to claim 7, wherein the at least one storage device comprises a memory-card receptacle for holding an external memory card.

9. The device according to claim 1, wherein there is an operating device by means of which at least two pieces of music can be selected.

10. The device according to claim 9, wherein by means of which at least the volume of the pieces of music can be adjusted.

11. The device according to claim 1, wherein there is a power supply which is connected to the electronic unit, wherein the power supply can be connected to an external power supply.

12. The device according to claim 11, wherein the power supply can be connected to an external power supply by means of a USB port.

13. The device according to claim 1, wherein there is a WLAN module which is connected to the electronic unit.

14. The device according to claim 1, wherein there is a Bluetooth module which is connected to the electronic unit.

15. The device according to claim 1, wherein a motor for actuating a toy figure, one that is removable arranged on or in the base body, wherein the electronic unit is designed to activate the motor if the closure body is at least partially distanced from the base-body opening.

16. A music module for a jewellery box, comprising at least one loudspeaker for playing at least one piece of music and with an electronic unit playing at least two pieces of music.
